(19) United States
(12) Patent Application Publication
(10) Pub. No.: US 2003/0204656 A1
(43) Pub. Date: Oct. 30, 2003

(54) PDA to PCMCIA universal adapter

(76) Inventor: Philip Ha, West Hills, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/137,712

(22) Filed: Apr. 30, 2002

(51) Int. Cl. G06F 13/00

(52) U.S. Cl. 710/301; 710/315

(57) ABSTRACT

A PDA functional module adapter for interconnecting a PDA module with the PCMCIA interface of a computer, the adapter comprising an adapter circuit having a PCMCIA interface, a PDA module interface, a logic and bus controller for coordinating the burst data functions of the computer with the burst data of a PDA module, a control block for verifying the electrical interconnection of a computer to the PCMCIA interface and for opening electrical communication between a computer interconnected with the PCMCIA interface and the logic and bus controller, and a memory device containing identifying information of a functional module for use with the adapter.

Personal Digital Assistants (PDAs) are handheld devices that combine computing, telephone/fax, networking, and other functional features in one unit. They are sometimes referred to as handheld computers. A typical PDA may function as a cellular phone, fax sender, and personal organizer. Unlike portable computers, most PDAs began as pen-based, using a stylus rather than a keyboard for input. This means that they also incorporated handwriting recognition features. Some PDAs may also react to voice input by using voice recognition technologies. PDAs are also called palmtops, hand-held computers or pocket computers.

A strength of certain PDAs has been the easy upgradability through the use of functional “modules” that may be installed in expansion slots provided in the PDA units. The Handspring® Visor® PDA makes extensive use of functional modules to vastly increase the capabilities and upgradability of the PDA. These functional modules may provide the PDA any number of additional functions, including, for example: networking, faxing, MP3 and MPEG playing, Global Positioning Satellite (GPS) communication and cartography, digital imaging, wireless communication, fingerprint recognition, FM/AM/TV/Satellite tuning, additional memory, universal remote-control, educational resources, media scanning, and digital recording capabilities.

As the popularity of PDAs has increased, so has the proliferation of manufacturers and types of functional modules available for PDAs. Typically, PDA users buy several different modules for the PDA in order to tailor the functionality of the PDA device to suit the needs of the user. For example, the user may need a PDA with voice recognition, networking, faxing, and MP3 playing capability. This typically requires a separate module for each function desired. The cost of the modules requires a substantial investment by the user, perhaps even greatly exceeding the cost of the PDA device itself. Thus, it would be desirable to provide a means for increasing the usability of functional PDA modules beyond only PDA platforms to include other platforms, such as desktop and laptop computers, so as to maximize the utility of the modules.

Additionally, for those users wishing to incorporate additional functional features into, for example, a lap-top or desktop computer, past systems have required the user to purchase a separate functional module suitable only for use on the lap-top computer via the serial port, the USB port, or the PCMCIA slot. Thus, a PDA user that desires network capability on both a PDA unit and a lap-top computer may need to purchase two separate modules, greatly increasing the expense and inconvenience of using the system in return for the added capability of the system. As can be seen, it would be desirable to have a means of using a single module that would be suitable for both PDA computing platforms and desktop and laptop computer platforms.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram showing the functional components of a universal PCMCIA/PDA module adapter;

FIG. 2 is a circuit diagram of a universal PCMCIA/PDA module adapter;

FIG. 3 is a top view of one configuration of a universal PCMCIA/PDA module adapter;

FIG. 4 is a block diagram showing the electrical and functional components of a universal PCMCIA/PDA module adapter; and

FIG. 5 is a block diagram showing the functional components of a universal PCMCIA/PDA module.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

A first aspect of the present invention comprises an adapter for interconnecting a Personal Digital Assistant (PDA) module with the standard Personal Computer Memory Card International Association (PCMCIA) slot of a laptop or desktop general-purpose computer. In this manner the computer, via its PCMCIA card slot, may access the functional features provided by the PDA module. In past systems, a user purchased separate modules, each suitable for use on a single computing platform. By providing an interface between a PDA module and the PCMCIA slot of the computer, a functional PDA module may be used identically in both the PDA for which it was intended as well as a laptop or desktop computer having a PCMCIA slot. As is readily appreciated, this greatly increases the utility of the PDA module.

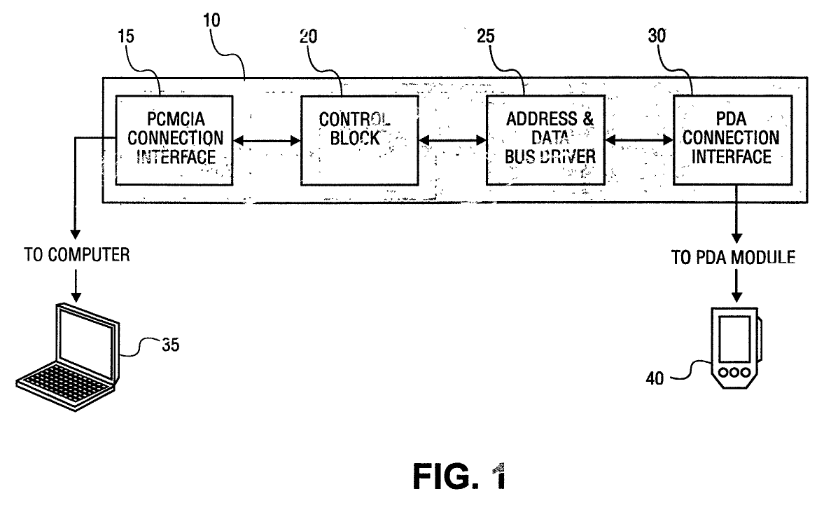

FIG. 1 is a block diagram showing the electrical and functional components of a universal PCMCIA/PDA module adapter for interconnecting a PDA functional module or PDA device with the standard PCMCIA slot of a computer. An adapter 10 comprises an adapter circuit 11 having a PCMCIA connection interface 15, a control block 20, a logic and bus controller 25, and a PDA connection interface 30.

PCMCIA connection interface 15 comprises a 68-pin PCMCIA socket connector configured to allow connection of the adapter 10 into any PCMCIA card slot of a computer. The 68-pin PCMCIA connector of PCMCIA connection interface 15 is preferably chosen such that it complies with the standard signaling used by PCMCIA devices. Also, adapter 10 includes a control block 20 electrically connected to PCMCIA connection interface 15.

Electrically connected to control block 20 is a logic and bus controller 25. Electrically connected to logic and bus controller 25 is PDA connection interface 30. PDA connection interface 30 is preferably a 68-pin header connector configured to connect PDA module 40 to adapter 10. As is apparent, however, the structure of the PDA module to be connected will dictate the structure of the corresponding PDA connection interface 30. Thus, a Handspring® module will likely require a somewhat structurally different PDA connection interface 30 than would a Palm® module. With respect to a Handspring® module connector, the module interface has some similar signal arrangements and definitions as a typical PCMCIA connection interface 15 but the operations of the signals may be somewhat different. For this reason, logic and bus controller 25 may be included to make the data flow properly between PCMCIA connection interface 15 and PDA connection interface 30.

PCMCIA connection interface 15 and PDA connection interface 30 are preferably located on opposite ends of adapter 10 to facilitate interconnection of a computer 35 and a PDA module 40. The PCMCIA connector of computer 35 provides a number of important functional components from computer 35 for use by adapter 10 and, as described later, the PDA module 40 connected thereto. These functions include a direct current voltage power supply or VDC. This voltage supply may have a value of about 3.3 VDC and supply power to components of adapter 10 and PDA module 40. Also provided is a ground connection that acts as the common power return for all components.

The PCMCIA slot also provides voltage sense signal lines to allow adapter 10 to request proper VDC (commonly 3.3 VDC) from the computer, and also “card detect” signal lines which may detect and indicate when adapter 10 is fully inserted into the PCMCIA slot. Input and output control signal lines operate to handle all communication between computer 35 and adapter 10. These lines also provide for the timing and direction of data flow between computer 35 and adapter 10. Also typically included in the PCMCIA computer slot is a data bus for handling the information exchange between computer 35 and adapter 10, as well as an address bus for routing and placing the information exchanged to the appropriate location. The adapter may also include connections to interface with the PCMCIA slot reset control line for initializing all components of adapter 10 to a known starting state.

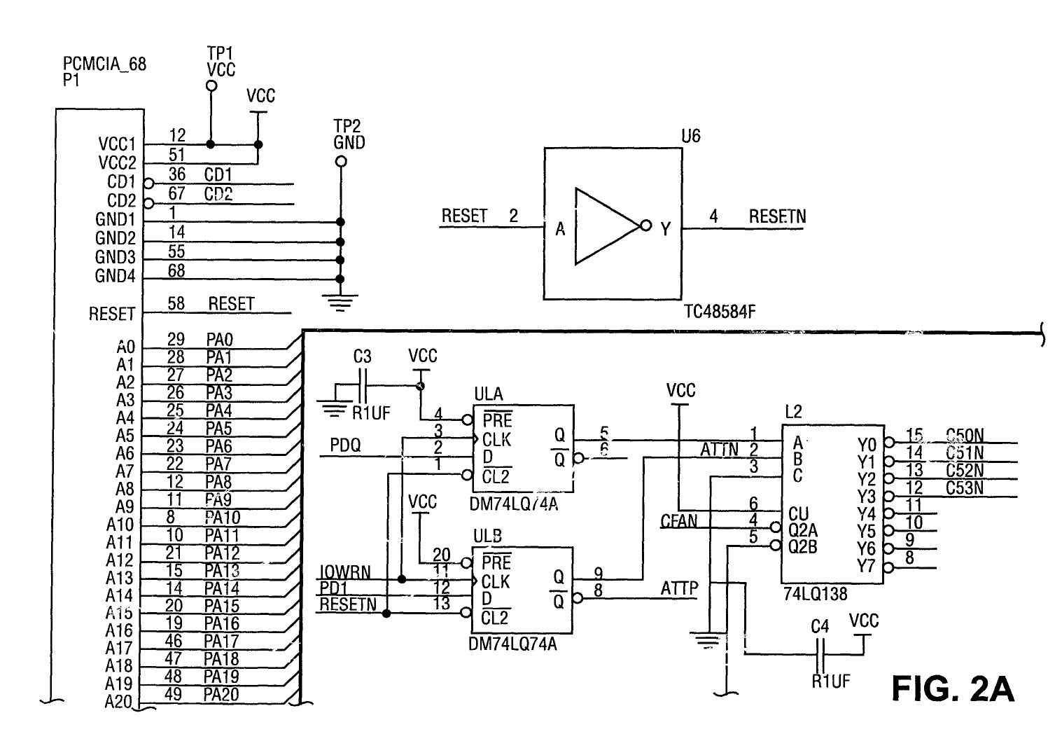

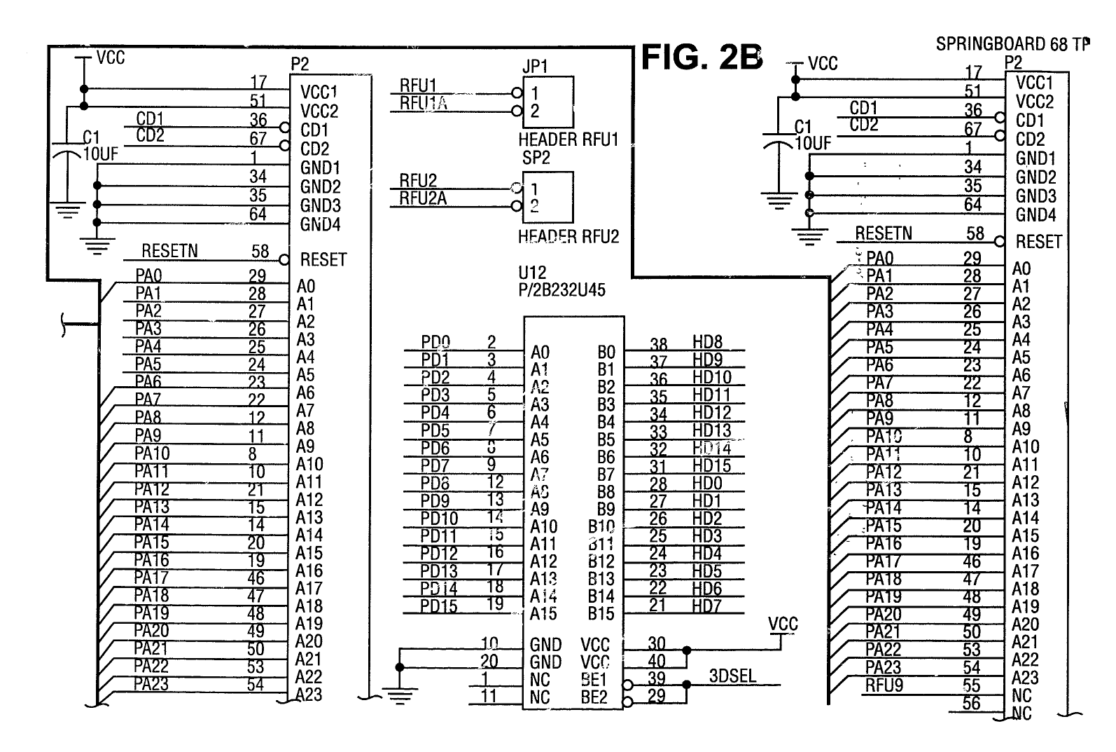

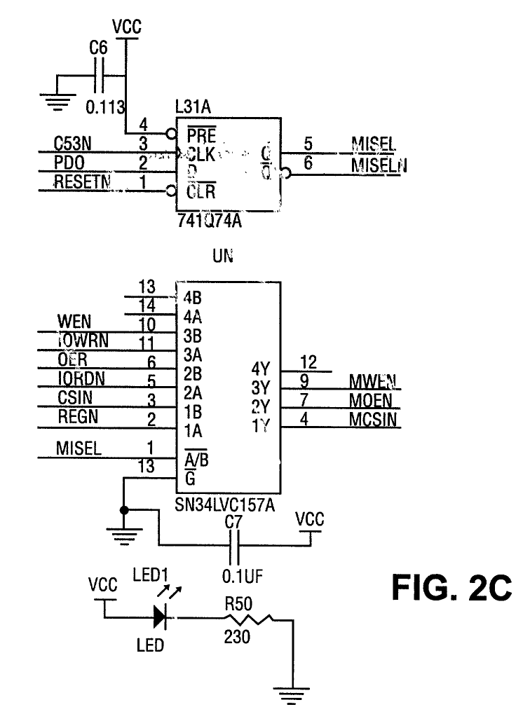

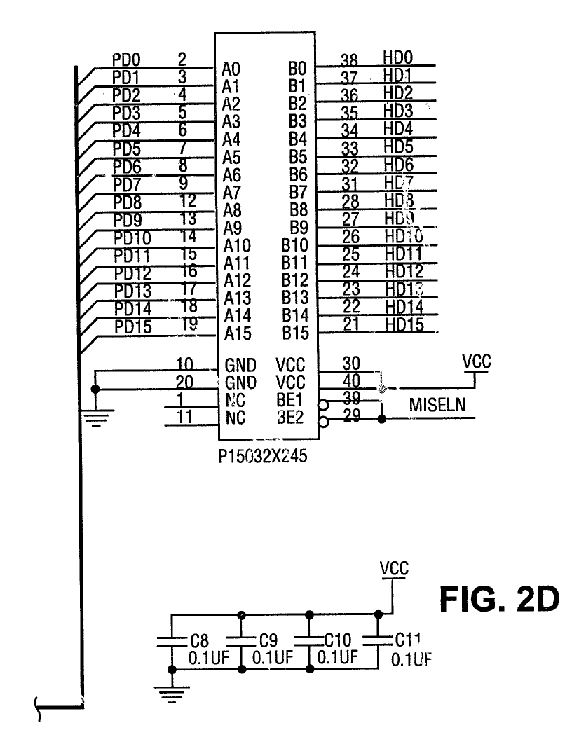

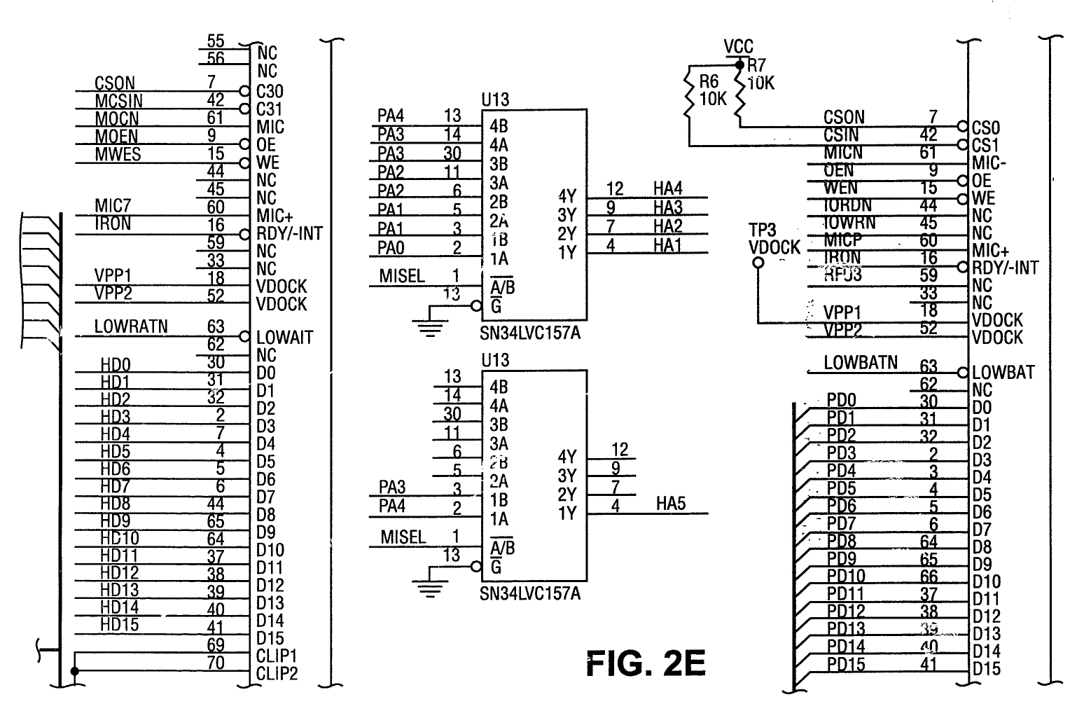

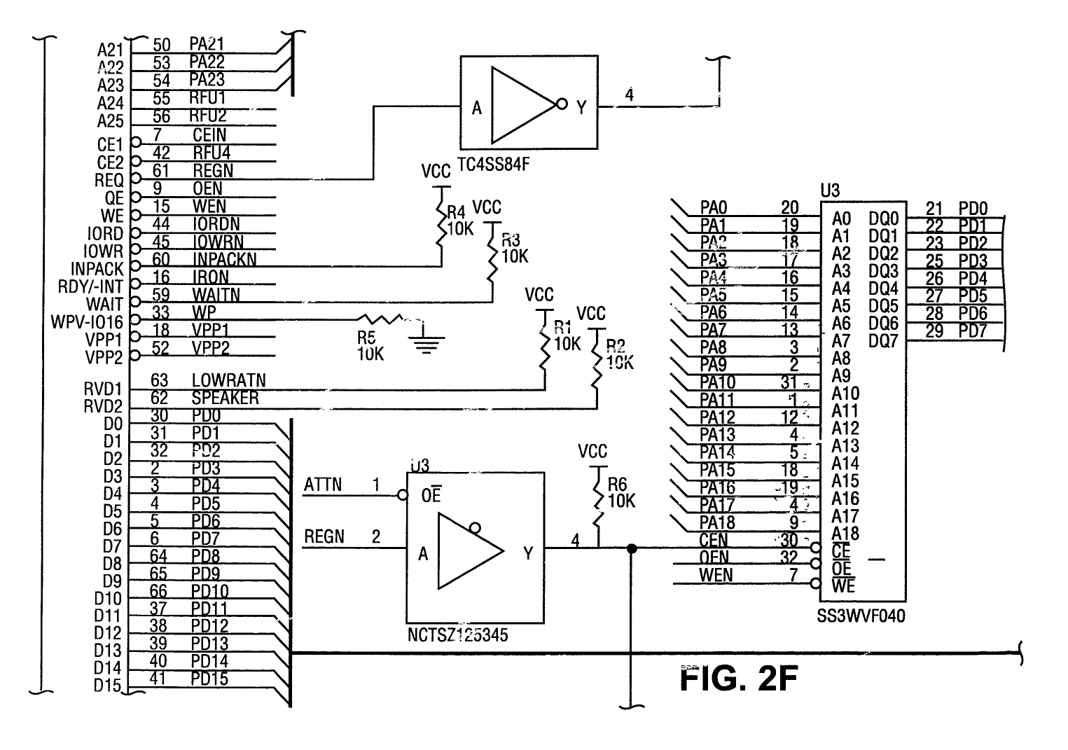

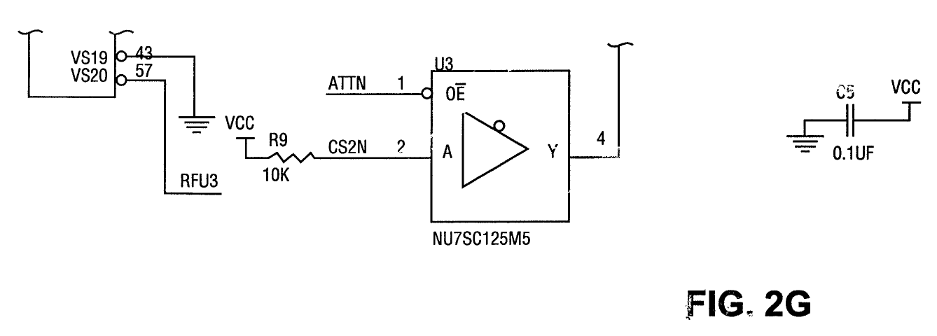

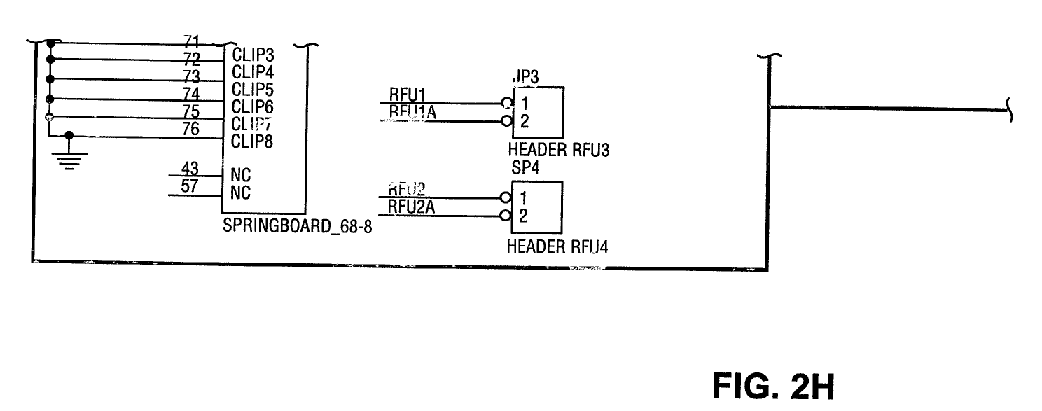

Turning again to a description of components of adapter 10, one of the most important hardware components of the adapter 10 is the logic and bus controller 25. Referring to FIG. 2, a circuit layout of a preferred configuration of an adapter 10 is shown. It should be understood that FIG. 2 represents only one way of applying the teachings of the present invention. Other alternatives may exist for practicing applicant's invention without departing from the spirit and the scope of the claimed invention.

With respect to logic and bus controller 25, the major components include D-Flip Flop registers [U1A, U1B] that hold the bus selection code from the computer software application and driver. Whenever the RESET control line is active, the output Q, pin 5 of U1A and pin 9 of the U1B will be latched to logic 0 values. The D-Flip Flop register U1A holds the least significant bit (LSB) of the bus selection code and the D-Flip Flop register U1B holds the most significant bit (MSB) of the bus selection code. With these two registers, four possible bus selection codes may be selected when the computer software/driver writes the IO commands to the data lines PD0 and PD1.

Logic and bus controller 25 also includes an inverter U7. The inverter U7 ensures that 3-bit decoder U2 decodes the bus selection codes and validates the chip select signals CS0N, CS1N, CS2N and CS3N in the memory mode but not in the attribute memory mode or IO (Input/Output) mode. The 3-bit decoder U2, together with the D-Flip Flop registers U1A, U1B and inverter U7, decodes 4 bus selection codes and activates the chip select signals as set forth in the table below:

| IO | | Chip select | | | | |
|---|---|---|---|---|---|---|
| Write to | | CS | | | | |
| P1 | P0 | 3N | 2N | 1N | 0N | |
| 0 | 0 | 0 | 0 | 0 | 1 | To access boot ROM of module 40 |
| 0 | 1 | 0 | 0 | 1 | 0 | To access memory device of PDA module 40 |
| 1 | 0 | 0 | 1 | 0 | 0 | To access memory device of adapter 10 |
| 1 | 1 | 1 | 0 | 0 | 0 | To select memory access to PDA module 40 |

D-flip flop register U9 latches either the memory or IO access mode to PDA module 40 once selected by the 3-bit decoder. The output signal MISEL provided at pin 5 drives U8, U11, U12 and U13 in the IO mode. Output signal MISELN provided at pin 6 drives U10 in the memory mode. When the RESET signal is activated U9 is set to the IO mode. Quadruple 2 to 1 selector U8 is configured such that if the IO mode is selected, then the control signals IOWRN, IORDN and REG that are responsible for the IO communication from the PCMCIA connector are routed to respective outputs at MWEN, MOEN and MCS1N. Conversely, if the memory mode is selected, then the control signals WEN, OEN and CS1N that are responsible for the memory communication are routed to respective outputs at MWEN, MOEN and MCS1N. The MWEN, MOEN and MCS1N are then connected to PDA connection interface 30.

Memory device U3 may be a FLASH programmable memory device containing the Card Information Structure (CIS) and the ID of PDA module 40. In this manner, the device U3 functions so that the software and operation system detect the functionality of the module and operate accordingly. Tri-state buffer U4 allows the manufacturer to access memory device U3 and program the appropriate CIS and ID for the specific PDA module 40. It also ensures that the access is granted when the chip select CS2N is activated by the 3-bit decoder U2. The second tri-state buffer U5 allows the computer 35 software or operating system to read the CIS and ID information of the module that is programmed into the memory device U3 of the adapter. As can be appreciated, the functionality of each module inserted into PDA connection interface 30 may dictate the programming of the CIS by the operating software. Through this programming of the CIS, the module will “look” like a PCMCIA card to host computer 35.

Logic and bus controller 25 coordinates burst data functions of computer 35 with the burst data of PDA module 40 inserted into PDA connection interface 30. Because the burst data of computer 35 is normally different than the burst data from PDA module 40, the PDA burst data may be “translated” by logic and bus controller 25 in order to be usable by computer 35. Similarly, burst data from computer 35 may be “translated” by logic and bus controller 25 in order to be usable by PDA module 40.

Adapter 10 further comprises a data bus switch U10 and an address bus switch U11 as shown in FIG. 2. Data bus switch U10 may be an electronic switch that serves as a gate for passing the normal 16-bit data bus signal arrangement from PCMCIA connection interface 15 to the interface of PDA module 40 when the memory mode is selected. Switch U12 may be an electronic switch that serves as a gate to pass the swapped 16-bit data bus signal arrangement from PCMCIA connection interface 15 to the interface of PDA module 40 when the IO mode is selected. In this case, the lower 8-bit data from computer 35 via the PCMCIA connection becomes the upper 8-bit data of PDA module 40 and the upper 8-bit data from computer 35 via the PCMCIA connection becomes the lower 8-bit data of PDA module 40.

Address bus switch U11 may be a quadruple 2 to 1 selector that, when in the IO mode, rearranges and shifts the PCMCIA address lines PA0, PA1, PA2 and PA3 to the left one position, providing connection to the module lines HA1, HA2, HA3 and HA4, respectively. In the memory mode, address bus switch U11 connects the PCMCIA address lines PA1, PA2, PA3 and PA4 to module address lines HA1, HA2, HA3 and HA4, respectively. Component U13 may be a quadruple 2 to 1 selector that rearranges and shifts the PCMCIA address line PA4 to the left one position to connect to the module address lines HA5 in the IO mode. In the memory mode, U11 passes the PCMCIA address line PA5 to the module address line HA5.

Adapter 10 may further include additional software components that facilitate interconnection of PDA module 40 and computer 35 via adapter 10. Adapter 10 may be configured to operate under either a DOS or Window 9x operating system. At power up or after a RESET signal is issued, adapter 10 may be configured to a reset state in the IO mode. A custom utility or driver may be included for reading the information in memory device U3 that contains the card information structure (CIS) and the ID of PDA module 40. The custom utility may thereby determine the functionality and preferred settings of PDA module 40. The utility or driver may then set up the PCMCIA port address, interrupt and power according to the preferred configuration. Also, the utility or driver may determine which communication, IO or memory read/write mode is used. If the memory read/write mode is used, the utility or driver follows the instructions as set forth in the table above to send: (a) a command of accessing PDA module 40 memory device, CS3N; (b) a command to select any preferred memory device, CS0N, CS1N or CS2N; and (c) an indicator that the adapter is ready for data transfers from computer 35 to PDA module 40 or vise versa. Once the above configuration is complete, a third party software application may be used.

Adapter circuit 11 of adapter 10 functions as a connector conversion circuit that rearranges the data, address bus, I/O and memory control signal lines from PCMCIA connection interface 15 and PDA connection interface 30. The operation of the adapter 10 will now be generally described.

In use, PCMCIA connection interface 15 of adapter 10 is inserted into the PCMCIA slot of computer 35. The 68-pin connector of PCMCIA connection interface 15 connects to the PCMCIA pin connector of computer 35. PDA module 40 may also be connected to PDA connection interface 30 to electrically connect PDA module 40 to adapter 10. Following interconnection of adapter 10 and the computer via the PCMCIA slot, the control block 20 is configured to electrically verify that PCMCIA connection interface 15 has actually connected to a computer's PCMCIA attachment. One method by which control block 20 verifies a connection is by sending a test signal to a so-called “ID pin” on the 68-pin connector of PCMCIA connection interface 15. Then, if connected to a working PCMCIA slot, the ID pin will return a verification signal. If not, then no verification signal will be received. In such a case, adapter 10 may be configured having an error light or indicator that visually or audibly indicates to the user that adapter 10 is not properly connected to a computer's PCMCIA slot.

Once control block 20 has verified the electrical interconnection of computer 35 and PCMCIA connection interface 15, control block 20 opens the circuit between logic and bus controller 25 to allow electrical communication between computer 35 and logic and bus controller 25 via PCMCIA connection interface 15.

Also, the system may include a software program that facilitates communication between the host computer and the PDA module. This software program may be functionally similar to existing programs included in the PDA modules and/or PDA units that provide data communication between the PDA and the module. With respect to the module-to-PCMCIA adapter, however, the software program may be tailored to work with the communication protocols required by the PCMCIA system of the host computer.

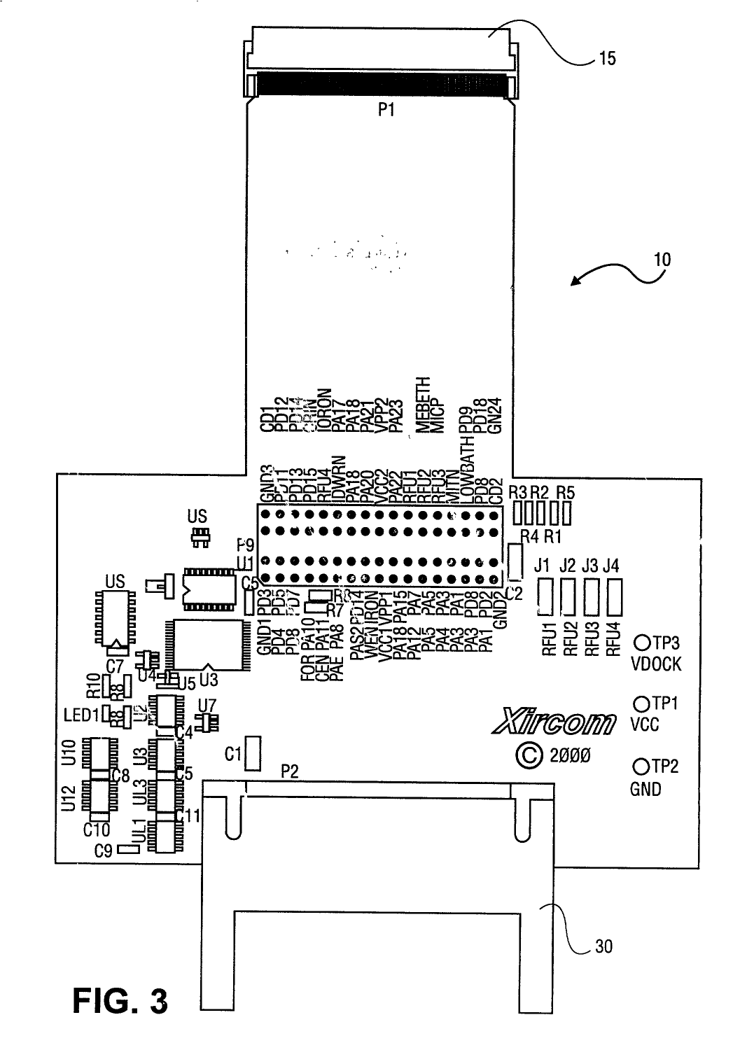

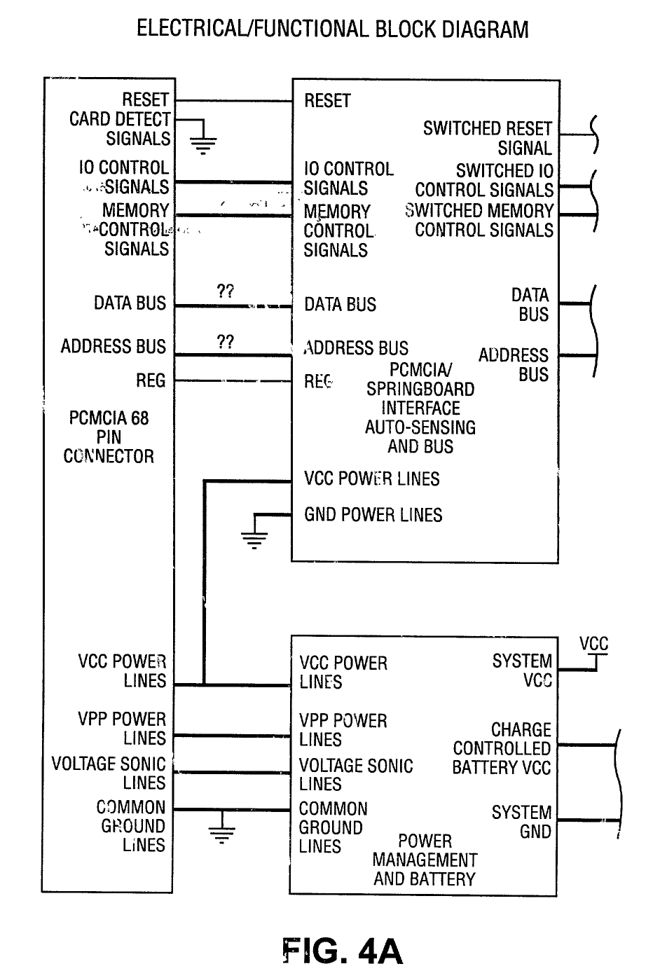

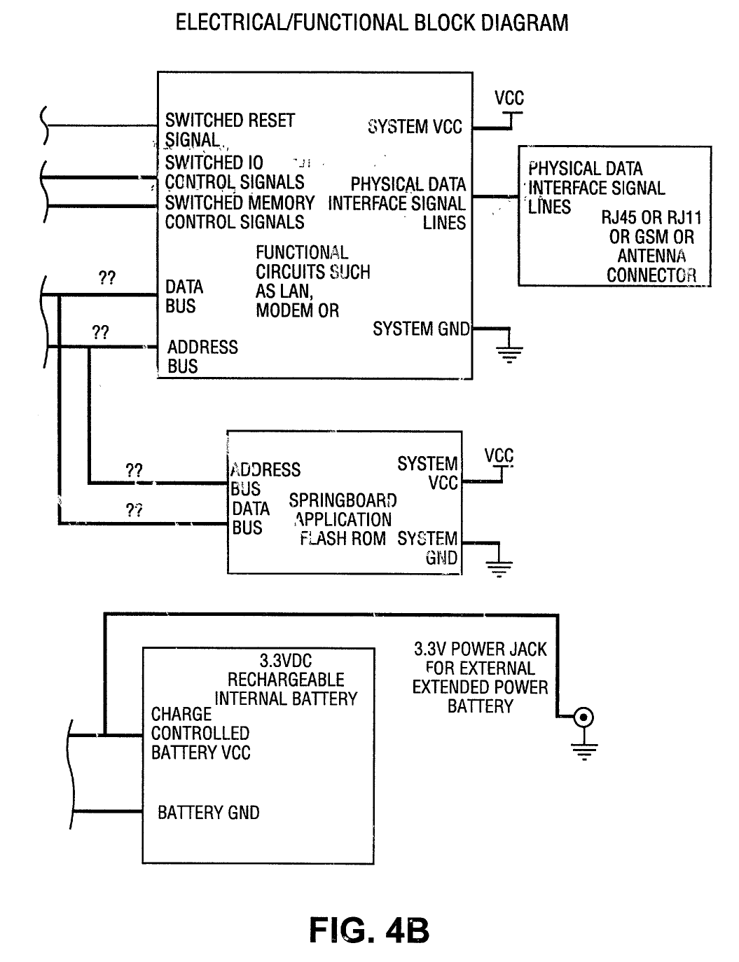

FIG. 2 shows one configuration of a circuit diagram of a universal PCMCIA/PDA module adapter constructed in accordance with the present invention. FIG. 3 shows a physical model of a universal PCMCIA/PDA module adapter 10. FIG. 4 is a block diagram showing the electrical and functional components of a universal PCMCIA/PDA module adapter.

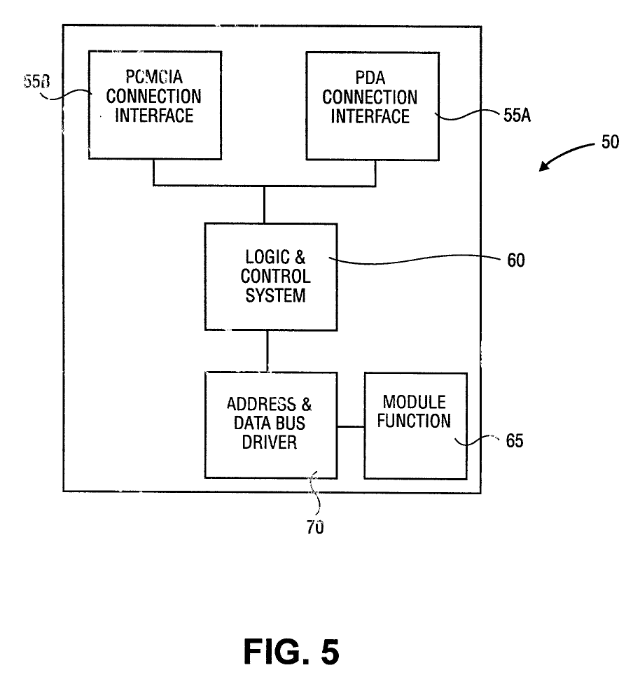

FIG. 5 shows universal PDA module 65 that may work in either a PDA unit or a standard laptop or desktop computer without the need for a universal PCMCIA/PDA module adapter 10. Universal PDA module 65 may be functionally similar to adapter 10 in that the major functional components of adapter 10 have been incorporated into universal PDA module 65 itself.

Universal PDA module 65 includes both a PDA interface 55a and a PCMCIA connection interface 55b such that universal PDA module 65 may be connected to either the PCMCIA interface of a common computer 35 or to the interface connection of PDA module 40. PDA connection interface 55a and PCMCIA connection interface 55b are single 68-pin PCMCIA socket connectors configured to interchangeably allow connection of the module into both a PCMCIA card slot of computer 35 or PDA module 40 via the same structure. Alternatively, connection interface 55a may be a discrete component from interface 55b. A separate configuration may be necessary wherein the PDA interface requires a connector structurally distinct from the 68-pin connector required by the PCMCIA card slot of computer 35.

For example, Handspring® uses a module interface for its PDAs that is structurally compatible with a 68-pin connector, and thus, the connection interface 55a and 55b may be configured as a single 68-pin connector. Other PDAs may use alternate modules having a connection interface that is be compatible with a 68-pin socket connector. In such case, it may be that the connection interfaces 55a and 55a be separate and distinct structural components. In that situation, PCMCIA connection interface 55b may comprise a 68-pin connection socket and PDA connection interface 55a may comprise any number of connectors suitable for interfacing with the particular model of PDA. It should be understood, however, that the 68-pin connector is only chosen since it is the standard attachment interface for a computer PCMCIA card slot. Obviously though, if that standard PCMCIA attachment interface were to change from a 68-pin connector, the teachings of the present invention would nonetheless be applicable to the alternate attachment interface.

Similar to adapter 10 described above, universal PDA module 65 includes a logic and control system 60 electrically connected to the interfaces 55a/55b. Electrically connected to the logic and control system 60 is an address and data bus driver 70. Address and data bus driver 70 is in electrically connected to the functional portion of universal PDA module 65.

The functional portion of universal PDA module 65 refers generally to the structures required to perform the function of the module, e.g., digital imaging, digital recording, networking, wireless web access, etc. In past modules, the functional portion of the module essentially comprised the entirety of the module, and was interfaced directly with the PDA. In applicant's invention, the functional portion of universal PDA module 65 has been combined with the structure and functions of the adapter circuit 11 that was described above to eliminate the need for a structurally separate adapter if it is desired to use universal PDA module 65 in an alternate computing platform such as a laptop or desktop computer.

In use, universal PDA module 65 may be connected to a PDA or to an alternate computing platform such as a laptop or desktop computer. When universal PDA module 65 is connected to a PDA, PDA interface 55a may be configured to connect directly to the functional portion of universal PDA module 65, such that the adapter circuit components, including logic and control system 60 and address and data bus driver 70 are excluded from the connection. This configuration may be used when the functional portion of universal PDA module 65 is configured to work compatibly with the PDA via the PDA interface 55a without the need for the translation/conversion as was described above in connection with the adapter circuit 11.

Alternatively, universal PDA module 65 may be configured to connect directly to the functional portion of universal PDA module 65 when connected to a computer via PCMCIA interface 55b, such that logic and control system 60 and address and data bus driver 70 are excluded from the connection. This configuration may be used if the functional portion of universal PDA module 65 is configured to work compatibly with a computer via a PCMCIA interface 55b without the need for the translation/conversion as was described above in connection with adapter circuit 11.

Also, universal PDA module 65 may be configured such that logic and control system 60 and address and data bus driver 70 as well as the associated components and structures described above in connection with adapter 10 are included in the connection between the functional portion of universal PDA module 65 and either connection interface 55a or 55b. Thus, regardless of whether universal PDA module 65 is connected to a PDA via PDA interface 55a or a computer or laptop via PCMCIA interface 55b, logic and control system 60 and address and data bus driver 70 and associated components and structures described above are included in the connection.

Universal PDA module 65 is preferably configured such that, following interconnection of module 65 and (1) a computer's PCMCIA slot via PCMCIA interface 55b, or (2) a PDA via PDA interface 55a, logic and control system 60 may be configured to electrically determine whether universal PDA module 65 is connected to a computer via PCMCIA slot 55b or a PDA via PDA interface 55a. One method by which logic and control system 60 verifies a connection is by sending a test signal to a so-called “ID pin” on PDA interface 55a and an “ID pin” on PCMCIA interface 55b. If connected to a working PCMCIA slot or a functioning PDA, the respective ID pin returns a verification signal. If not connected, then no verification signal is returned. Universal PDA module 65 may be configured having an indicator that visually or audibly indicates to the user that the module is properly connected to a computer's PCMCIA slot, to a PDA, or is not properly connected to either.

Depending on whether universal PDA module 65 is attached to a computer or a PDA, logic and control system 60 and address and data bus driver 70 and associated components and structures described above may be configured to appropriately manage the connection of, and communication between, the PDA or computer and the functional portion of the module via the respective interfaces 55a/55b.

While certain features of the invention have been illustrated and described herein, many modifications, substitutions, changes, and equivalents will now occur to those skilled in the art. Examples have been provided to show embodiments of the present invention being applied to laptop or notebook computers, but other products are envisioned. It is, therefore, to be understood that the appended claims are intended to cover all such modifications and changes as fall within the true spirit of the invention.

1. A module, comprising:
an adapter circuit having a Personal Computer Memory Card International Association (PCMCIA) interface compatible with a PCMCIA slot of a computer and a Personal Digital Assistant (PDA) interface compatible with a PDA device, the adapter circuit further including a control block coupled between the PCMCIA interface and the PDA interface to verify an electrical connection of the computer and the PDA device.

2. The module of claim 1, wherein the control block coordinates burst data functions received at the PCMCIA interface from the computer with burst data received at the PDA interface from the PDA device.

3. The module of claim 1, further comprising:
a nonvolatile memory coupled to the adapter circuit to store identifying information of the PDA device for use by the adapter circuit.

4. The module of claim 3 wherein the nonvolatile memory stores a card information structure (CIS) and an identification value of a module interconnected with the computer.

5. The module of claim 1 wherein the PCMCIA interface comprises a 68-pin connector.

6. The module of claim 1 wherein the PDA interface comprises a 68-pin connector.

7. The module of claim 1 wherein the PDA interface and the PCMCIA interface are separate from each other.

8. The module of claim 1 wherein the PDA interface and the PCMCIA interface comprise a single structure.

9. The module adapter of claim 1 wherein the control block includes:
a first switch for passing signals between the PCMCIA interface and the PDA interface; and
a second switch for rearranging PCMCIA address lines received at the PCMCIA interface and passed to the PDA interface.

10. A device, comprising:
an adapter circuit having a Personal Computer Memory Card International Association (PCMCIA) interface compatible with a PCMCIA slot of a computer and a Personal Digital Assistant (PDA) interface compatible with a PDA device, the adapter circuit further including a nonvolatile memory to store identifying information of the PDA device for use by the adapter circuit.

11. The device of claim 10, wherein the nonvolatile memory stores identifying information of the PDA device for use by the adapter circuit.

12. The device of claim 10 wherein the nonvolatile memory stores a card information structure (CIS) and an identification value of a module interconnected with the computer.

13. The device of claim 10 wherein the nonvolatile memory comprises a FLASH programmable memory device.

14. The device of claim 10 further including a first switch for passing signals between the PCMCIA interface and the PDA interface; and
a second switch for rearranging PCMCIA address lines received at the PCMCIA interface and passed to the PDA interface.

15. A system comprising:
a computer having a Personal Computer Memory Card International Association (PCMCIA) slot;
a Personal Digital Assistant (PDA) device; and
an adapter circuit having a PCMCIA interface compatible with the PCMCIA slot of the computer and a PDA interface compatible with the PDA device, the adapter circuit further including a control block coupled between the PCMCIA interface and the PDA interface to verify an electrical connection of the computer and the PDA device.

16. The system of claim 15, wherein the control block coordinates burst data functions from the computer and received at the PCMCIA interface with burst data from the PDA device and received at the PDA interface.

17. The system of claim 15, further comprising:
a nonvolatile memory coupled to the adapter circuit to store identifying information of the PDA device for use by the adapter circuit.

18. The system of claim 17 wherein the nonvolatile memory stores a card information structure (CIS) and an identification value of a module interconnected with the computer.

19. A method, comprising:
providing an adapter circuit having a Personal Computer Memory Card International Association (PCMCIA) interface compatible with a PCMCIA slot of a computer and a Personal Digital Assistant (PDA) interface compatible with a PDA device;
verifying an electrical connection between the computer coupled to the PCMCIA interface and the PDA device coupled to the PDA interface;
passing signals between the PCMCIA interface and the PDA interface; and
rearranging PCMCIA address lines received at the PCMCIA interface and passed to the PDA interface.

20. The method of claim 19, further including:
storing a card information structure (CIS) and an identification value of a module interconnected with the computer; and
storing identifying information of the PDA device for use by the adapter circuit.
